(19) United States
(12) Patent Application Publication
(10) Pub. No.: US 2015/0091731 A1
(43) Pub. Date: Apr. 2, 2015

(54) Rail vehicle comprising an induction smoke alarm

(71) Applicant: SIEMENS AKTIENGESELLSCHAFT, MUENCHEN (DE)

(72) Inventors: Michael Drews, Duesseldorf (DE); Thomas Gross, Wuppertal (DE)

(73) Assignee: SIEMENS AKTIENGESELLSCHAFT, MUENCHEN (DE)

(21) Appl. No.: 14/399,778

(22) PCT Filed: Apr. 4, 2013
(86) PCT No.: PCT/EP2013/057078

§ 371 Date: Nov. 7, 2014

(30) Foreign Application Priority Data
May 8, 2012 (DE) 102012207633.6

(51) Int. Cl. G08B 17/10

(52) U.S. Cl. CPC G08B 17/10
USPC 340/628

(57) ABSTRACT

A rail vehicle includes an aspirating or induction smoke alarm or detector which is connected by a line to at least one aspiration or induction end piece having a defined opening cross-section for collecting air samples. At least one line piece made of flexible material extends outward from the aspiration or induction end piece in the direction of the aspirating or induction smoke alarm or detector.

The invention relates to a rail vehicle comprising an induction smoke alarm which is connected via a line to at least one induction end piece of defined opening cross section for collecting air samples.

In such a rail vehicle, it is typical for a plurality of induction end pieces of defined opening cross section to be provided which are distributed, for example, over the interior of the vehicle. A line arrangement is used to connect them to the induction smoke alarm. This line arrangement has been formed hitherto by a rigid pipe system. In order to ensure a uniform air sample collection from monitoring regions within the rail vehicle, individual pipe pieces are adhesively bonded to one another and induction openings having defined bore diameters are made in these pipe pieces.

On account of a fit-out characteristic in the ceiling region of a rail vehicle in which, for example, air-conditioning ducts, light strips and cable runs are arranged, the installation of a rigid pipe system is associated with a high degree of expenditure.

Taking this as the starting point, the object of the invention is to develop a rail vehicle of the type stated at the outset such that the lines from the induction smoke alarm to the induction end pieces can be mounted in a simplified manner.

This object is achieved in the rail vehicle in that at least one line piece leaving the induction end piece in the direction of the induction smoke alarm is formed from flexible material.

Here, the line can be constructed in its entirety from flexible hose and/or pipe pieces such that the entire line between the induction smoke alarm and the at least one induction end piece is held flexibly. In this way, flexibility in the choice of laying routes for the line in the vehicle is also achieved since internal fittings or obstacles can be flexibly bypassed and mounting fixtures do not have to be adapted to each fit-out situation.

Mounting of the line can be further simplified by virtue of the fact that the opening cross section is defined with the aid of a heat-shrinkable hose. This ensures lower expenditure in terms of related maintenance work. Such work will be required to be less extensive since in the prior art it also concerns vandalism and sabotage. It is of importance here that the sleeves hitherto used for defining the opening cross section are easily destructible and the induction openings as such are then visible and can be vandalized.

By contrast, the at least one induction end piece can be arranged in a concealed manner in an interior of the rail vehicle. In a favorable arrangement variant, the at least one induction end piece can be mounted in the region of a luggage rack.

It can be seen that the above procedure for laying a line between the induction smoke alarm and the induction end piece can be performed in the same way for all the induction end pieces provided in the interior of the rail vehicle. In this case, all the lines would be part of a line arrangement which, if required, can have T-pieces, angle pieces and/or reducing means. This procedure is more assembly-friendly than the solutions in the prior art in which individual rigid pipe pieces are frequently adhesively bonded to one another. By contrast with the adhesively bonded pipe system, there thus result lower maintenance and repair costs and presentation in LCC analyses is simpler.

An exemplary embodiment of the invention will be explained in more detail below with reference to the drawings, in which:

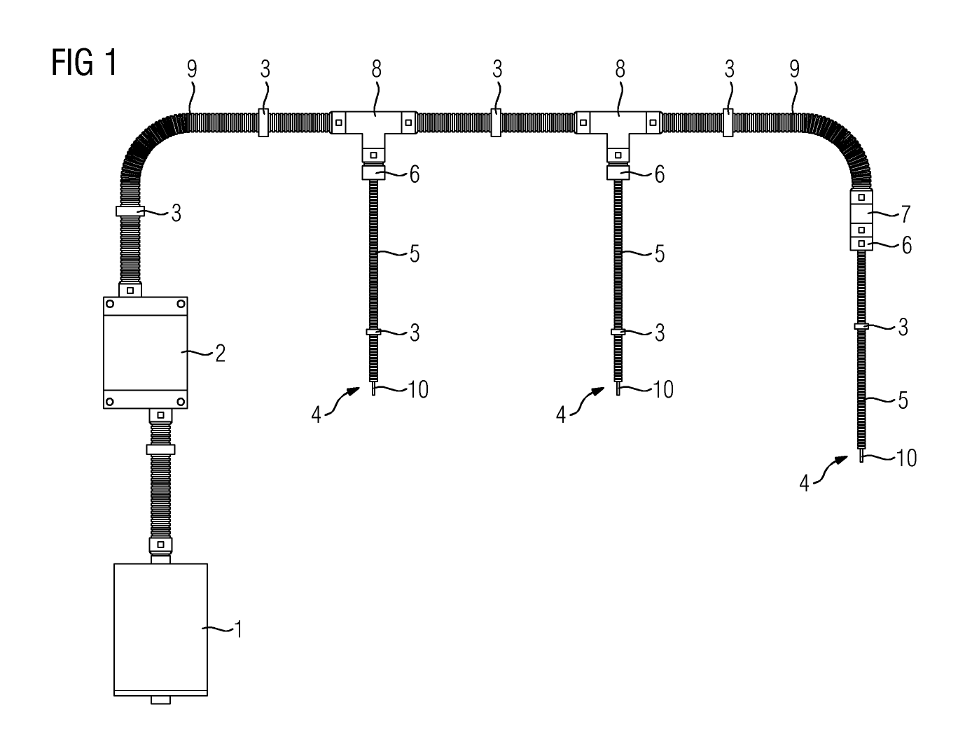

FIG. 1 shows a schematic view of a smoke alarm arrangement,

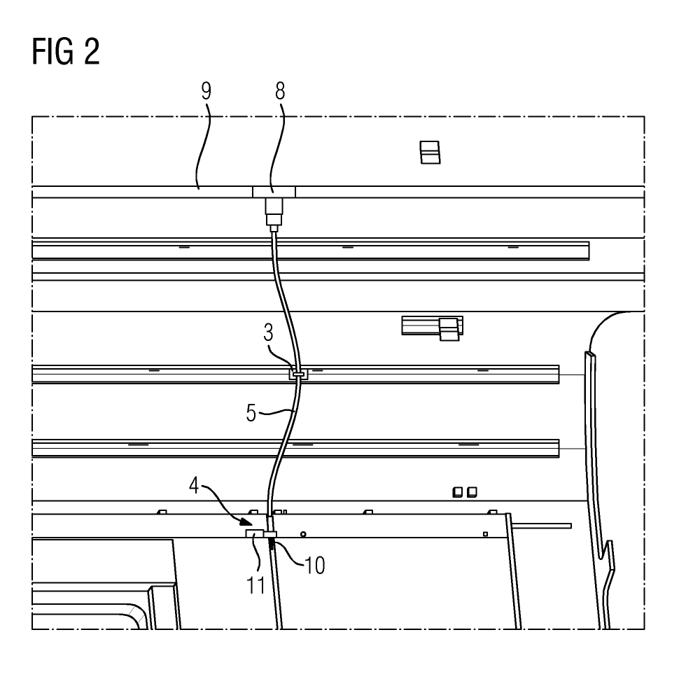

FIG. 2 shows a perspective view of a part of the smoke alarm arrangement of FIG. 1 in an installed situation.

As can be seen from FIG. 1, an induction smoke alarm 1 is connected via an air filter 2 to a line arrangement which can be mounted in the interior of a rail vehicle with the aid of various holding elements 3.

In the exemplary embodiment illustrated, a total of three induction end pieces 4 are connected to a flexible main pipeline 9 via flexible hose or pipe pieces 5 of small diameter via reducing pieces 6 and a coupling 7 or T-pieces 8. Here, the main pipeline 9, with the incorporation of the T-pieces 8, extends from the air filter 2 as far as the coupling 7 which is assigned to the induction end piece 4 situated furthest away.

The smoke alarm arrangement is thus formed as a whole, at least from the air filter 2, exclusively by flexible hose and pipe pieces. To connect the individual line sections 5, 9, use is made of commercially available reducing pieces, T-pieces and, if appropriate, angle pieces, as are customary in conventional screwing systems having sealing inserts.

It should be stressed that the induction end pieces 4 are determined to have a defined opening diameter with the aid of shrunk-on heat-shrinkable hose sections 10.

It can be seen from FIG. 2 that the induction end piece 4 is connected from the main pipe line 9 via the T-piece 8 and the flexible hose or pipe piece 5. The induction end piece 4 is situated in a side wall region of a rail vehicle in which a luggage rack is mounted.

The induction end piece 4 is positioned via a holding element 11 which is fastened on the bodyshell side.

1-6. (canceled)

7. A rail vehicle, comprising:
an induction smoke alarm;
at least one induction end piece having a defined opening cross section for collecting air samples; and
a line connected between said induction smoke alarm and said at least one induction end piece, said line having at least one line piece formed of flexible material outgoing from said at least one induction end piece in a direction toward said induction smoke alarm.

8. The rail vehicle according to claim 7, wherein said line is constructed in its entirety of at least one of flexible hose or pipe pieces.

9. The rail vehicle according to claim 7, which further comprises a heat-shrinkable hose defining said opening cross section of said at least one induction end piece.

10. The rail vehicle according to claim 7, wherein said at least one induction end piece is concealed in an interior of the rail vehicle.

11. The rail vehicle according to claim 10, wherein said at least one induction end piece is mounted in the vicinity of a luggage rack.

12. The rail vehicle according to claim 8, wherein:
said at least one induction end piece includes a plurality of induction end pieces;
said line is one of a plurality of lines; and
at least one of T-pieces, angle pieces or reducing pieces connect said induction smoke alarm through said lines to said induction end pieces.
